(19) United States
(12) Patent Application Publication
(10) Pub. No.: US 2023/0311797 A1
(43) Pub. Date: Oct. 5, 2023

(54) BUMPER SYSTEM FOR AN AUTOMOTIVE VEHICLE

(71) Applicant: Atlas Technologies Holding B.V., Helmond (NL)

(72) Inventor: Storm POTKAMP, Arnhem (NL)

(21) Appl. No.: 18/025,239

(22) PCT Filed: Sep. 14, 2021
(86) PCT No.: PCT/EP2021/075224

§ 371 Date: Mar. 8, 2023

(30) Foreign Application Priority Data
Sep. 15, 2020 (NL) 2026470

(51) Int. Cl. B60R 19/34; B60R 19/18

(52) U.S. Cl. CPC B60R 19/34; B60R 19/18

(57) ABSTRACT

The present invention relates to an automotive vehicle, the automotive vehicle comprising a distal end, at least one crash, and a bumper system provided at the distal end, wherein the bumper system is configured to limit damage to the automotive vehicle in a low speed collision with an object at the distal end by absorbing a collision energy, wherein the bumper system comprises a bumper beam and at least one crash box, wherein the bumper beam is configured to absorb at least 35%, preferably at least 40%, more preferably at least 45% of the collision energy in an RCAR low-speed structural crash test, and wherein the at least one crash box is configured to absorb at least 35%, preferably at least 40%, more preferably at least 45% of the collision energy in the RCAR low-speed structural crash test for limiting a maximum intrusion distance of the object.

### FIELD OF THE INVENTION

The invention relates to a bumper system for an automotive vehicle and to an automotive vehicle comprising said bumper system.

The project leading to this application has received funding from the European Union's Horizon 2020 research and innovation program under grant agreement No. 848620.

### BACKGROUND OF THE INVENTION

When an automotive vehicle comes into contact with an external object, for example another automotive vehicle, the external object and/or the automotive vehicle will be damaged. Generally the automotive vehicle is damaged. In order to limit damage the automotive vehicle usually comprises a bumper system at a distal end thereof, i.e. front and/or rear end.

For automotive collisions a distinction is made between a low speed collision and a high speed collision. In this case a collision is considered low speed up to 15 km/h and collisions at speeds higher than 15 km/h are considered high speed. During a low speed collision the main concern is to reduce the damage to the vehicle, while for a high speed collision the main concern is the safety of the occupants.

The present invention is aimed at reducing damage to an automotive vehicle in a low speed collision. Said aim is particularly relevant for expensive automotive vehicles, as repair costs tend to be expensive as well. Expensive automotive vehicles are for example automotive vehicles comprising solar panels.

Vehicles that are at least partly charged by solar power comprise solar panels that are provided on the upper surface of the automotive vehicle and are for charging one or more battery packs of the automotive vehicle. The battery packs provide at least part of the required energy for driving the automotive vehicle. In order to maximize the solar charging capacity there is a need to maximize the solar panel area on the upper surface of the automotive vehicle. The solar panel area is related to the amount of kilometres that can be driven on only the sun annually, wherein a larger solar panel area means more annual solar kilometres. Because the solar panels are an expensive component, damage to the solar panels in a low speed collision should be prevented.

### OBJECT OF THE INVENTION

It is an object of the invention to provide an automotive vehicle which suffers less damage in a low speed collision.

It is another object of the invention to provide an automotive vehicle able to travel more annual solar kilometres.

### SUMMARY OF THE INVENTION

In order to achieve at least one object, an automotive vehicle is provided comprising:
a distal end,
at least one crash rail extending in a longitudinal direction of the vehicle towards the distal end, the crash rail comprising a free end,
a bumper system provided at the distal end, wherein the bumper system is configured to limit damage to the automotive vehicle in a low speed collision with an object at the distal end by absorbing a collision energy, wherein the bumper system comprises
   a bumper beam extending substantially perpendicular to a longitudinal axis of the automotive vehicle,
   at least one crash box extending substantially parallel to the longitudinal axis of the automotive vehicle, the at least one crash box comprising a first end and an opposite second end, wherein the first end is connected to the bumper beam, and wherein the second end is connected to the free end of the at least one crash rail of the automotive vehicle,
   wherein the bumper beam is configured to absorb at least 35%, preferably at least 40%, more preferably at least 45% of the collision energy in an RCAR low-speed structural crash test, and wherein the at least one crash box is configured to absorb at least 35%, preferably at least 40%, more preferably at least 45% of the collision energy in the RCAR low-speed structural crash test for limiting a maximum intrusion distance of the object.

RCAR stands for Research Council for Automobile Repairs, hereafter ROAR. The RCAR low-speed structural crash test is a widely used test used for determining damage to an automotive vehicle.

The bumper system of the automotive vehicle is configured to limit the maximum intrusion distance of the object. By limiting the maximum intrusion distance a larger part of the automotive vehicle remains undamaged during the low-speed collision. This reduces the damage cost, and increases the space available for e.g. the trunk and, in the case of a vehicle comprising solar panels, the available area for these solar panels. This is beneficial for expensive automotive vehicles, as the limited intrusion distance will result in less damage compared to a higher intrusion distance.

This is in particular beneficial for automotive vehicles having solar panels on an upper surface thereof. By limiting the maximum intrusion distance, a larger upper surface area of the automotive vehicle may be used for providing solar panels without damaging them in a low speed collision. In turn, providing more solar panels will increase the amount of annual solar kilometres.

The maximum intrusion distance is reduced by having the bumper beam absorb at least 35%, preferably at least 40%, more preferably at least 45% of the collision energy. In known bumper systems comprising a bumper beam and at least one crash box the bumper beam is configured to absorb less than 35% of the collision energy, wherein the at least one crash box is configured to absorb at least 65% of the collision energy in a 15 km/h collision.

As the bumper beam absorbs a higher amount of the collision energy, the crash boxes may absorb less. Hence, the crash boxes may be shorter. The shorter crash boxes provide a shorter bumper system in the longitudinal direction. A shorter bumper system may provide more room for example the trunk of the automotive vehicle.

In an embodiment the automotive vehicle comprises a chassis, wherein an outer body work is provided on the chassis, the outer body work comprising an upper surface comprising at least one solar panel.

In an embodiment of the automotive vehicle, in the low speed collision the maximum intrusion distance along the distal end defines a maximum intrusion line extending substantially parallel to the distal end at a distance thereof, wherein in top view the at least one solar panel extends from the maximum intrusion line away from the distal end.

In an embodiment of the automotive vehicle, the at least one crash rail is connected at the free end thereof to the second end of the at least one crash box and at an opposite end thereof to the chassis, wherein in top view the at least one solar panel extends from the free end of the at least one crash rail away from the distal end.

In an embodiment of the automotive vehicle, the bumper system comprises two crash boxes which are located at a distance from each other in a direction substantially perpendicular to the longitudinal axis of the automotive vehicle.

In an embodiment of the automotive vehicle, the at least one crash box comprises a hollow beam, wherein an internal volume of the hollow beam comprises an aluminium foam fill.

The aluminium foam fill increases the energy that can be absorbed by the crash box, thereby decreasing the intrusion distance. An advantage of the foam fill is that the length of the crash box may be decreased, because the same energy can be absorbed by a shorter crash box. Hence, leaving more room available for e.g. the trunk, or solar panels.

In an embodiment of the automotive vehicle, the hollow beam has a wall thickness between 1-3 mm. Said thickness is relatively high, increasing the energy that can be absorbed by the crash box, while maintaining a simple construction.

In an embodiment of the automotive vehicle, the bumper beam and/or the at least one crash box are made from a material comprising aluminium.

In an embodiment of the automotive vehicle, in cross-sectional view the bumper beam has a fill ratio of at least 25%.

In an embodiment of the automotive vehicle, the bumper beam has a wall thickness between 3-5 mm. Said thickness is relatively high, increasing the energy that can be absorbed by the bumper beam, while maintaining a simple construction.

In an embodiment of the automotive vehicle, the bumper beam is curved in top view.

In an embodiment of the automotive vehicle, the bumper beam has a length, wherein the length is equal to or greater than a distance between two crash boxes and at least smaller than or equal to a distal width of the distal end of the automotive vehicle.

In an embodiment of the automotive vehicle, the bumper beam and the at least crash box are configured to absorb the collision energy by plastic deformation thereof.

The present invention further relates to a bumper system configured to be provided at a distal end of an automotive vehicle, wherein the bumper system is configured to limit damage to the automotive vehicle in a low speed collision with an object at the distal end by absorbing a collision energy, wherein the bumper system comprises
a bumper beam,
at least one crash box extending substantially perpendicular to the bumper beam, the at least one crash box comprising a first end and an opposite second end, wherein the first end is connected to the bumper beam, and wherein the second end is configured to be connected to a crash rail of the automotive vehicle,
wherein the bumper beam is configured to absorb at least 35%, preferably at least 40%, more preferably at least 45% of the collision energy in an RCAR low-speed structural crash test, and wherein the at least one crash box is configured to absorb at least 35%, preferably at least 40%, more preferably at least 45% of the collision energy in the RCAR low-speed structural crash test for limiting a maximum intrusion distance of the object.

### BRIEF DESCRIPTION OF THE FIGURES

Embodiments of the system and the method will be described by way of example only, with reference to the accompanying schematic drawings in which corresponding reference symbols indicate corresponding parts, and in which:

FIG. 1 schematically shows a top view of an embodiment of an automotive vehicle according to the invention comprising an embodiment of a bumper system according to the invention.

FIG. 2A schematically shows a top view of an RCAR low-speed structural crash test set up.

FIG. 2B schematically shows a side view of the RCAR low-speed structural crash test set up.

FIG. 3A-3C schematically show top views of different phases during the RCAR low-speed structural crash test.

FIG. 4 schematically shows a cross-sectional top view of a distal end of an automotive vehicle comprising an embodiment of a bumper system according to the invention, in particular showing a maximum intrusion distance.

FIG. 5 schematically shows a perspective view of an embodiment of a bumper system according to the invention.

FIG. 6 schematically shows a perspective view of the bumper system of FIG. 5 connected to crash rails.

FIG. 7 schematically shows a cross-section of an embodiment of a bumper beam of a bumper system according to the invention.

FIG. 8 schematically shows a cross-section of an embodiment of a crash box of a bumper system according to the invention.

### DETAILED DESCRIPTION OF THE FIGURES

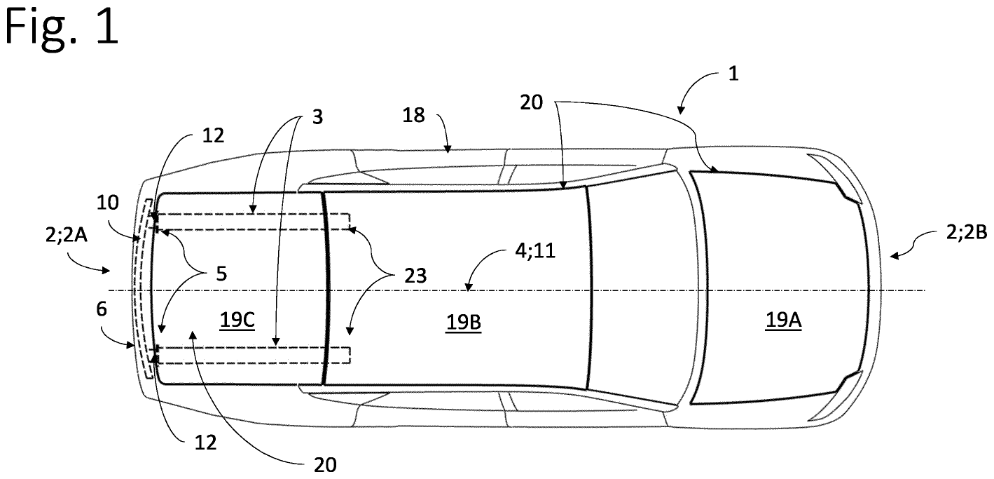

Turning to FIG. 1 an automotive vehicle 1 is shown, in particular an automotive vehicle for transporting at least one person. The automotive vehicle 1 comprises a distal end 2. In the shown figure the rear end 2A of the automotive vehicle 1 is the distal end 2. The front end 2B of the automotive vehicle 1 may also be the distal end 2.

At least one crash rail 3, here two crash rails 3, extends in a longitudinal direction 4 of the vehicle 1 towards the distal end 2. The crash rail 3 comprises a free end 5. At an opposite end 23 thereof the crash rail 3 is connected to a chassis (not shown) of the automotive vehicle 1.

A bumper system 6 is provided at the distal end 2. The bumper system 6 is configured to limit damage to the automotive vehicle 1 in a low speed collision 7 with an object 8 at the distal end 2 by absorbing a collision energy.

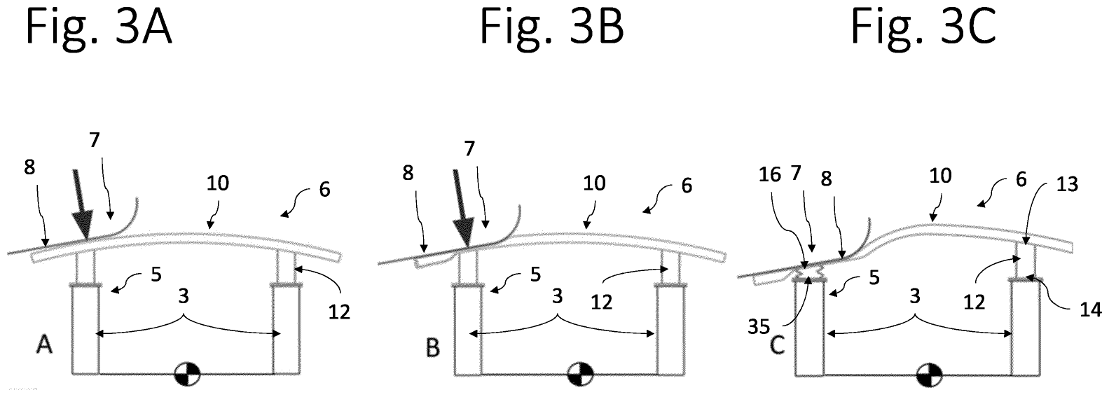

The bumper system 6 comprises a bumper beam 10 extending substantially perpendicular to a longitudinal axis 11 of the automotive vehicle 1. The bumper system 6 further comprises at least one crash box 12, here two crash boxes 12, extending substantially parallel to the longitudinal axis 11 of the automotive vehicle 1. The crash box 12 comprises a first end 13 and an opposite second end 14, see FIG. 3C. The first end 13 is connected to the bumper beam 10. The second end 14 is connected to the free end 5 of the at least one crash rail 3 of the automotive vehicle 1.

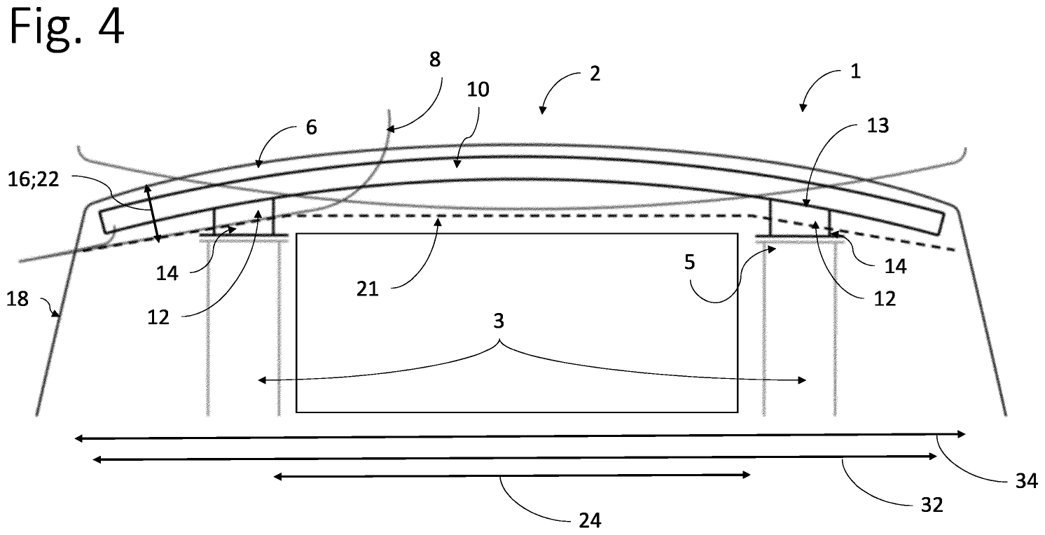

The two crash boxes 12 are located at a distance 24 from each other in a direction substantially perpendicular to the longitudinal axis 11 of the automotive vehicle 1, see FIG. 4.

The bumper beam 10 is configured to absorb at least 35%, preferably at least 40%, more preferably at least 45% of the collision energy in an RCAR low-speed structural crash test. The at least one crash box 12 is configured to absorb at least 35%, preferably at least 40%, more preferably at least 45% of the collision energy in the RCAR low-speed structural crash test 15 for limiting a maximum intrusion distance 16 of the object 8.

An outer body work 18 is provided on the chassis. The outer body work 18 comprises an upper surface 19 comprising at least one solar panel 20. In the shown embodiment the front upper surface 19A, mid upper surface 19B and rear upper surface 19C comprise solar panels 20.

The bumper system 6 is located within a volume enclosed by the outer body work 18, as can be seen in the top view of FIG. 1.

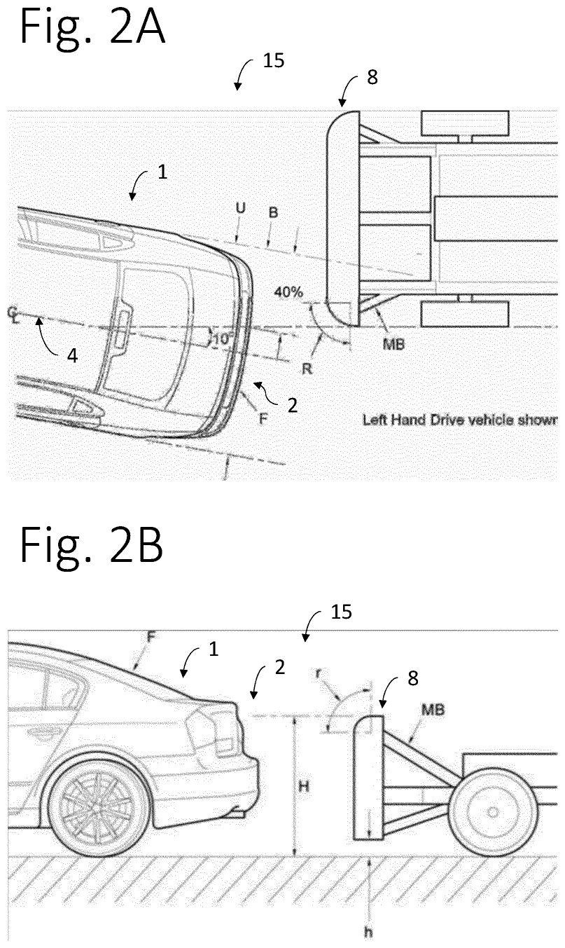

Turning to FIGS. 2 and 3 the RCAR low-speed structural crash test 15 is schematically shown. The FIGS. 2 and 3 are taken from the RCAR low-speed structural crash test protocol, Appendix 2, Issue 2.2 from July 2011.

FIGS. 2A and 2B show respective top and side views of an automotive vehicle 1 undergoing the RCAR low-speed structural crash test 15 prior to collision. The automotive vehicle 1 will collide with an external object 8 at a speed of 15 km/h. This is considered low speed, wherein the crash rail 3 is configured to remain intact.

The automotive vehicle 1 will collide under an angle of 10 degrees relative to the longitudinal axis 11 of the automotive vehicle 1 with the external object 8.

FIGS. 3A to 3C schematically show different moments during the deformation. FIG. 3A shows the situation just before impact with the bumper beam, wherein an external object 8 is located adjacent the bumper beam 10 of the bumper system 6. The outer body work 18 is not shown.

FIG. 3B shows the situation wherein a section, in particular an outer section of the bumper beam 10 is fully crushed.

FIG. 3C shows the situation wherein the bumper beam 10 and the crash box 12 are fully deformed. In this situation the total collision energy of the low-speed crash is absorbed, wherein the bumper beam 10 has absorbed at least 35%, preferably at least 40%, more preferably at least 45% of the collision energy, and wherein the crash box 12 has absorbed at least 35%, preferably at least 40%, more preferably at least 45% of the collision energy. As it is a low-speed structural crash test 15, the crash rail 3 is not damaged.

The bumper beam 10 and the at least one crash box 12 are configured to absorb the collision energy by plastic deformation 35 thereof, as shown in FIG. 3C.

FIG. 4 schematically shows a cross-sectional top view of the distal end 2 of the automotive vehicle 1, wherein the bumper system 6 is shown. The low-speed crash induces a maximum intrusion distance 16 along the distal end 2. The maximum intrusion distance 16 along the distal end 2 defines a maximum intrusion line 21 extending substantially parallel to the distal end 2 at a distance 22 thereof.

The maximum intrusion line 21 extends at least partly between the free end 5 of the crash rails 3 and the distal end 2.

In top view the at least one solar panel 20 (not shown) extends from the maximum intrusion line 21 away from the distal end 2. This allows for an increased solar panel 20 area compared to having the solar panels 20 extend from the free end 5 of the crash rails 3. In the low-speed collision damage to the solar panels 20 will be prevented or at least limited, because the solar panels 20 do not extend beyond the maximum intrusion distance 16.

The at least one solar panel 20 may instead extend from the free end 5 of the at least one crash rail 3 away from the distal end 2. This configuration still allows for a large solar panel area while damage to the solar panels is further prevented, or limited.

Having a shorter maximum intrusion distance 16 allows the crash rails 3 to extend further to the distal end 2. As the trunk is generally provided from the free end 5 of the crash rails 3 towards the opposite distal end 2 the trunk size can be increased.

The bumper beam 10 has a length 32. Said length 32 is equal to or greater than a distance 24 between two crash boxes 12 and at least smaller than or equal to a distal width 34 of the distal end 2 of the automotive vehicle 1.

The bumper beam 10 is curved, when seen in top view.

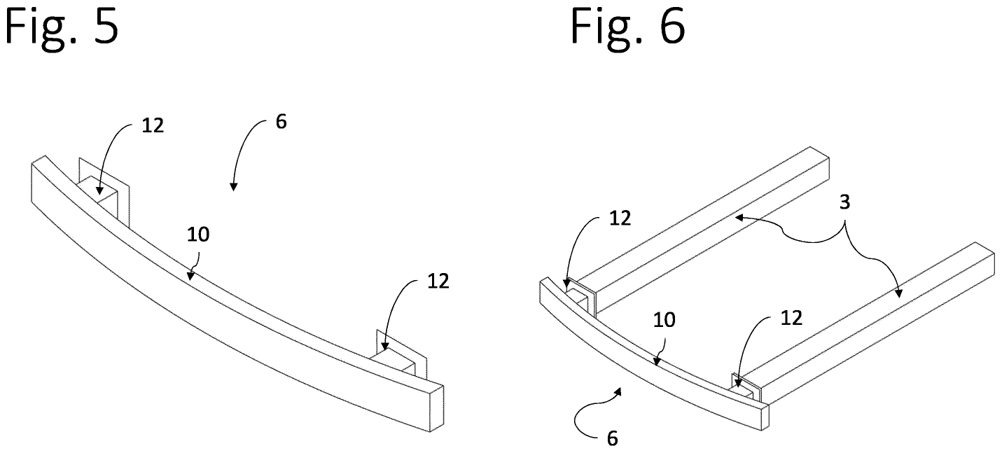

Turning to FIGS. 5 and 6 an embodiment of the bumper system 6 is shown, wherein in FIG. 6 the bumper system 6 is connected to two crash rails 3.

The bumper beam 10 and/or the at least one crash box 12 may be made from a material comprising aluminium. The bumper beam 10 and/or the at least one crash box 12 may be made entirely from an aluminium alloy.

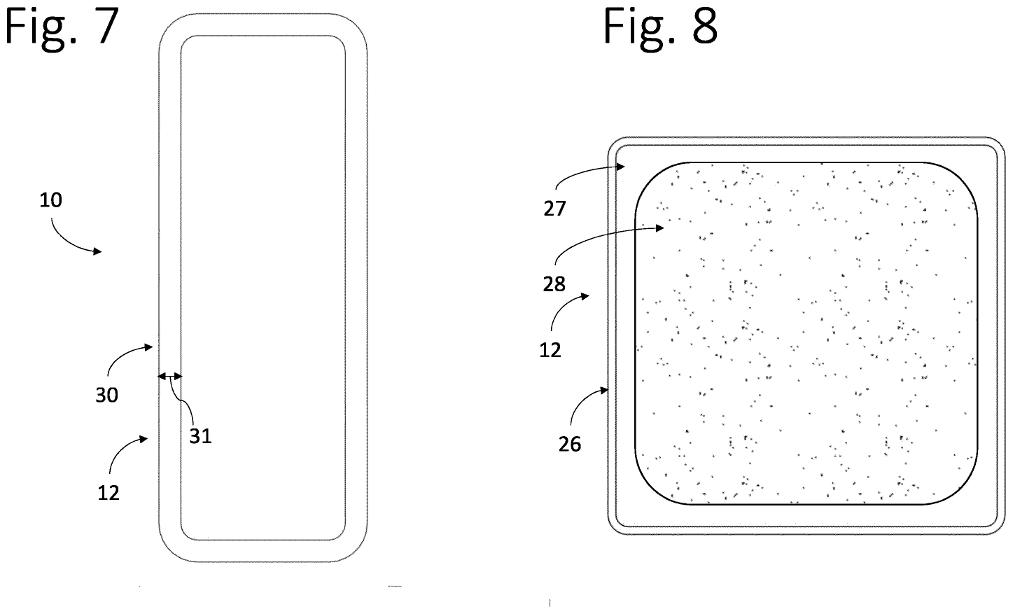

In cross-sectional view, as shown in FIG. 7, an embodiment of the bumper beam 10 has a fill ratio 30 of at least 25%. The fill ratio 30 is the amount of material within the outer circumference of the cross-section relative to the total cross-sectional area. A higher fill ratio may increase the amount of energy that can be absorbed by the bumper beam 10. A higher fill ratio 30 may therefore assist in limiting the intrusion distance during a collision.

The bumper beam 10 may have a wall thickness 31 between 3-5 mm. This embodiment is easy to manufacture, as it does not require a complex cross-sectional profile. The fill ratio 30 may also be achieved by a more complex cross-sectional profile.

FIG. 8 shows a cross-sectional view of an embodiment of the crash box 12. The crash box 12 comprises a hollow beam 26. An internal volume 27 of the hollow beam 26 comprises an aluminium foam fill 28. The aluminium foam fill 28 is shown schematically. The aluminium foam fill 28 may decrease the peak force on the crash box 12. The decreased peak force in turn allows the weight of the crash rails 3 to be lower.

The hollow beam 26 may have a wall thickness between 1-3 mm.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1. An automotive vehicle comprising:
a distal end,
at least one crash rail extending in a longitudinal direction of the vehicle towards the distal end, the crash rail comprising a free end,
a bumper system provided at the distal end, wherein the bumper system is configured to limit damage to the automotive vehicle in a low speed collision by absorbing a collision energy, wherein the bumper system comprises:
a bumper beam extending substantially perpendicular to a longitudinal axis of the automotive vehicle,
at least one crash box extending substantially parallel to the longitudinal axis of the automotive vehicle, the at least one crash box comprising a first end and an opposite second end, wherein the first end is connected to the bumper beam, and wherein the second end is connected to the free end of the at least one crash rail of the automotive vehicle,
wherein the bumper beam is configured to absorb at least 35%, preferably at least 40%, more preferably at least 45% of the collision energy in an RCAR low-speed structural crash test, and wherein the at least one crash box is configured to absorb at least 35%, preferably at least 40%, more preferably at least 45% of the collision energy in the RCAR low-speed structural crash test for limiting a maximum intrusion distance of the object.

2. The automotive vehicle according to claim 1, wherein the automotive vehicle comprises a chassis, wherein an outer body work is provided on the chassis, the outer body work comprising an upper surface comprising at least one solar panel.

3. The automotive vehicle according to claim 2, wherein in the low speed collision the maximum intrusion distance along the distal end defines a maximum intrusion line extending substantially parallel to the distal end at a distance thereof, wherein in top view the at least one solar panel extends from the maximum intrusion line away from the distal end.

4. The automotive vehicle according to claim 2, wherein the at least one crash rail is connected at the free end thereof to the second end of the at least one crash box and at an opposite end thereof to the chassis, wherein in top view the at least one solar panel extends from the free end of the at least one crash rail away from the distal end.

5. The automotive vehicle according to claim 1, wherein the bumper system comprises two crash boxes which are located at a distance from each other in a direction substantially perpendicular to the longitudinal axis of the automotive vehicle.

6. The automotive vehicle according to claim 1, wherein the at least one crash box comprises a hollow beam, wherein an internal volume of the hollow beam comprises an aluminium foam fill.

7. The automotive vehicle according claim 6, wherein the hollow beam has a wall thickness between 1-3 mm.

8. The automotive vehicle according to claim 1, wherein the bumper beam and/or the at least one crash box are made from a material comprising aluminium.

9. The automotive vehicle according to claim 1, wherein in cross-sectional view the bumper beam has a fill ratio of at least 25%.

10. The automotive vehicle according to claim 1, wherein the bumper beam has a wall thickness between 3-5 mm.

11. The automotive vehicle according to the preceding claim 1, wherein the bumper beam is curved in top view.

12. The automotive vehicle according to claim 5, wherein the bumper beam has a length, wherein the length is equal to or greater than a distance between two crash boxes and at least smaller than or equal to a distal width of the distal end of the automotive vehicle.

13. The automotive vehicle according to claim 1, wherein the bumper beam and the at least one crash box are configured to absorb the collision energy by plastic deformation thereof.

14. A bumper system configured to be provided at a distal end of an automotive vehicle, wherein the bumper system is configured to limit damage to the automotive vehicle in a low speed collision with an object at the distal end by absorbing a collision energy, wherein the bumper system comprises:
a bumper beam,
at least one crash box extending substantially perpendicular to the bumper beam, the at least one crash box comprising a first end and an opposite second end, wherein the first end is connected to the bumper beam, and wherein the second end is configured to be connected to a crash rail of the automotive vehicle,
wherein the bumper beam is configured to absorb at least 35%, preferably at least 40%, more preferably at least 45% of the collision energy in an RCAR low-speed structural crash test, and wherein the at least one crash box is configured to absorb at least 35%, preferably at least 40%, more preferably at least 45% of the collision energy in the RCAR low-speed structural crash test for limiting a maximum intrusion distance of the object.
